(19) United States
(12) Patent Application Publication
(10) Pub. No.: US 2014/0063068 A1
(43) Pub. Date: Mar. 6, 2014

(54) ACCOMMODATING DISPLAY DATA CORRESPONDING TO A SCANOUT AREA OF A GRAPHICS PROCESSOR WITHIN AN INCOMPATIBLE DISPLAY UNIT

(71) Applicants: PRAFUL JOTSHI, Pune (IN); Arpit Agrawal, Indore (IN)

(72) Inventors: PRAFUL JOTSHI, Pune (IN); Arpit Agrawal, Indore (IN)

(73) Assignee: NVIDIA Corporation, Santa Clara, CA (US)

(21) Appl. No.: 13/602,212

(22) Filed: Sep. 3, 2012

(51) Int. Cl. G09G 5/00

(52) U.S. Cl. 345/660

(57) ABSTRACT

A method includes defining, through a graphics driver component of a graphics processor of a computing device, a custom mode of displaying pixel data from the graphics processor on a display communicatively coupled to the computing device, and receiving, as an input through the custom mode, dimensional parameters of the display through the graphics processor. The custom mode is interpretable through an operating system executing on the computing device. The method also includes providing a virtual representation of the display through the operating system based on the received dimensional parameters of the display, and scaling, through the graphics processor, the pixel data corresponding to a scanout of the graphics processor to fit within the virtual representation of the display to provide a one-on-one mapping between a virtual display canvas corresponding to the scanout of the graphics processor and dimensions of the display.

### FIELD OF TECHNOLOGY

This disclosure relates generally to display systems and, more particularly, to accommodating display data corresponding to a scanout area of a graphics processor within an incompatible display unit.

### BACKGROUND

A graphics processor (e.g., Graphics Processing Unit (GPU)) of a computing device may process pixel data to be displayed within a display unit (e.g., a projector) coupled to the computing device. A scanout area of the graphics processor may have a fixed topology that may cause the pixel data displayed on the display unit to either overshoot the dimensions thereof or not fit therewithin. As a crude solution, the display unit may be displaced appropriately to capture all the pixel data therewithin. The aforementioned process may be cumbersome and/or subject to damage risk.

Hardware such as a pixel manipulator may be used to shrink or magnify the viewable area on the display unit through correspondingly either dropping some pixels or copying adjacent pixels therefor. In addition to expenses associated with the pixel manipulator, the aforementioned dropping or copying of pixels may decrease image quality considerably.

### SUMMARY

Disclosed are a method, an apparatus and/or a system of accommodating display data corresponding to a scanout area of a graphics processor within an incompatible display unit.

In one aspect, a method includes defining, through a graphics driver component of a graphics processor of a computing device, a custom mode of displaying pixel data from the graphics processor on a display communicatively coupled to the computing device, and receiving, as an input through the custom mode, dimensional parameters of the display through the graphics processor. The custom mode is interpretable through an operating system executing on the computing device. The method also includes providing a virtual representation of the display through the operating system based on the received dimensional parameters of the display, and scaling, through the graphics processor, the pixel data corresponding to a scanout of the graphics processor to fit within the virtual representation of the display to provide a one-on-one mapping between a virtual display canvas corresponding to the scanout of the graphics processor and dimensions of the display.

In another aspect, a display system includes a display unit including a number of individual displays, and a computing device communicatively coupled to the display unit. The computing device includes a memory including an operating system executing on the computing device, a number of graphics processors communicatively coupled to the memory, with each graphics processor of the number of graphics processors corresponding to an individual display of the number of individual displays, and a graphics driver component of the number of graphics processors to define a custom mode of displaying pixel data from the number of graphics processors on the display unit.

The custom mode is interpretable through the operating system executing on the computing device. The customer mode provides a capability to receive dimensional parameters of the display unit as an input through the number of graphics processors. The operating system is capable of providing a virtual representation of the display unit based on the received dimensional parameters of the display unit. The number of graphics processors is configured to scale the pixel data corresponding to a scanout of the plurality of graphics processors to fit within the virtual representation of the display unit to provide a one-on-one mapping between a virtual display canvas corresponding to the scanout of the plurality of graphics processors and dimensions of the display unit.

In yet another aspect, a non-transitory medium, readable through a computing device and including instructions embodied therein that are executable through the computing device, includes instructions to define, through a graphics driver component of a graphics processor of the computing device, a custom mode of displaying pixel data from the graphics processor on a display communicatively coupled to the computing device. The custom mode is interpretable through an operating system executing on the computing device. The non-transitory medium also includes instructions to receive, as an input through the custom mode, dimensional parameters of the display through the graphics processor, and instructions to provide a virtual representation of the display through the operating system based on the received dimensional parameters of the display.

Further, the non-transitory medium includes instructions to scale, through the graphics processor, the pixel data corresponding to a scanout of the graphics processor to fit within the virtual representation of the display to provide a one-on-one mapping between a virtual display canvas corresponding to the scanout of the graphics processor and dimensions of the display.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a display system, according to one or more embodiments.

FIG. 2 is a schematic view of a virtual display canvas corresponding to the display unit of the display system of FIG. 1.

FIG. 3 is a schematic view of interaction between a graphics driver component and a graphics processor of the display system of FIG. 1.

FIG. 4 is a schematic view of a virtual display canvas including the virtual representation of the display unit of the display system of FIG. 1.

FIG. 5 is a process flow diagram detailing the operations involved in accommodating display data corresponding to a scanout area of a graphics processor within an incompatible display unit, according to one or more embodiments.

Other features of the present embodiments will be apparent from the accompanying drawings and from the detailed description that follows.

### DETAILED DESCRIPTION

Example embodiments, as described below, may be used to provide a method, an apparatus and/or a system of accommodating display data corresponding to a scanout area of a graphics processor within an incompatible display unit. Although the present embodiments have been described with reference to specific example embodiments, it will be evident that various modifications and changes may be made to these embodiments without departing from the broader spirit and scope of the various embodiments.

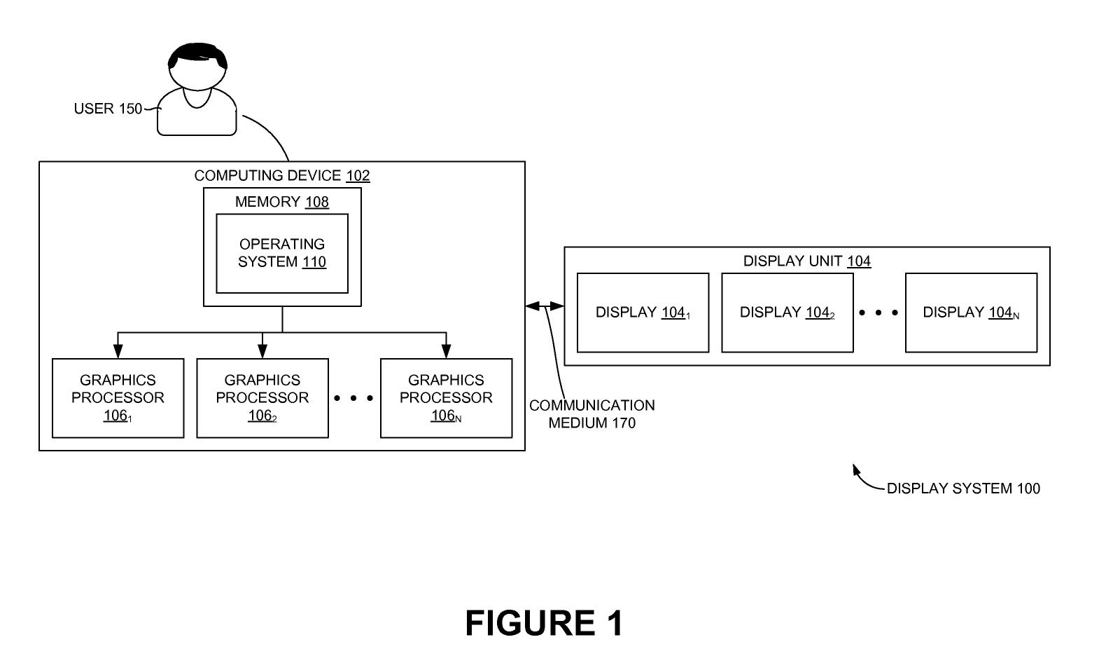

FIG. 1 shows a display system 100, according to one or more embodiments. In one or more embodiments, display system 100 may include a computing device 102 (e.g., a desktop computer, a laptop computer, a notebook computer) configured to have data associated therewith displayed on a display unit 104 (e.g., a wall projector). In one or more embodiments, display unit 104 may include a number of individual displays 104_{1-N} (e.g., Liquid Crystal Displays (LCDs)) configured to render data associated with computing device 102. For the aforementioned purpose, in one or more embodiments, computing device 102 may include a number of graphics processors 106_{1-N} (e.g., Graphics Processing Units (GPUs)) therein. In one or more example embodiments, one or more of the number of graphics processors 106_{1-N} may be part of a single graphics processor (e.g., a quad-core GPU). In another example embodiment, all of graphics processors 106_{1-N} may be part of the single graphics processor, with each port thereof corresponding to an individual display 104_{1-N}.

While exemplary embodiments have been discussed with regard to a single computing device 102, it is obvious that there may be more than one computing devices providing data to be rendered on the number of individual displays 104_{1-N}. It would then be obvious from the paragraphs below that only a minor modification to the processes discussed herein with regard to implementation with a single computing device 102 may be required. Also, although exemplary embodiments may include a central processor (e.g., Central Processing Unit (CPU)) to instruct graphics processors 106_{1-N}, the aforementioned central processor has not been shown in FIG. 1 for the sake of illustrative clarity.

In one or more embodiments, computing device 102 may include a memory 108 (e.g., volatile memory, non-volatile memory) communicatively coupled to graphics processors 106_{1-N}. While FIG. 1 shows a single memory 108 as being communicatively coupled to graphics processors 106_{1-N}, it is obvious that each of graphics processors 106_{1-N} may be associated with a separate memory. Alternately, memory 108 may include individual memories associated with graphics processors 106_{1-N}. Further, it is obvious that an operating system 110 may execute on computing device 102. FIG. 1 shows operating system 110 as being stored in memory 108 (e.g., non-volatile memory). In one or more embodiments, operating system 110 of computing device 102 may support a mosaic display mode where multiple graphics processors 106_{1-N} may be presented to operating system 110 as a single logical graphics processor.

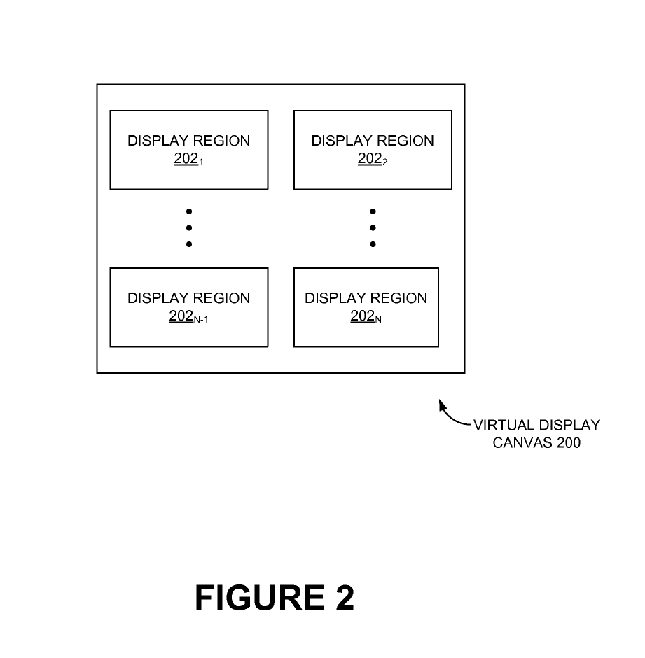

Thus, each individual display 104_{1-N} may define a unique uniform region with a virtual display canvas. FIG. 2 shows virtual display canvas 200 as including display regions 202_{1-N}, each of which corresponds to an individual display 104_{1-N}. In one or more embodiments, once graphics processors 106_{1-N} complete processing of data to generate display data, the aforementioned display data may be sent as one or more frames over a communication medium 170 (e.g., a cable, over a communication network such as a Local Area Network (LAN) and/or a Wide Area Network (WAN)) to corresponding individual displays 104_{1-N}. The transmission of pixel data for a frame over communication medium 170 following processing through graphics processors 106_{1-N} may be known as scanout. Thus, it is obvious that virtual display canvas 200 may correspond to a scanout area for a frame.

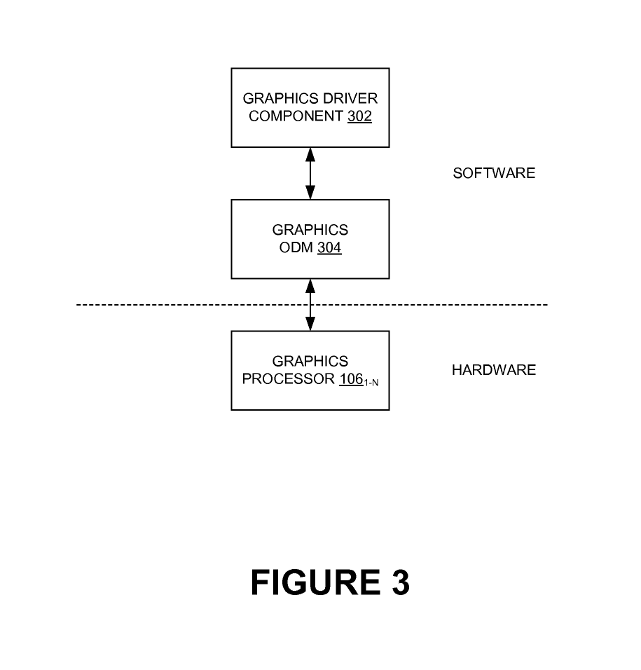

FIG. 3 shows interaction between a graphics driver component 302 (e.g., a software driver) and a graphics processor 106_{1-N}, according to one or more embodiments. In one or more embodiments, graphics driver component 302 may issue commands to graphics processor 106_{1-N} when a routine thereof is involved by a calling application program (e.g., executed on graphics processor 106_{1-N}). In one or more embodiments, an Original Design Manufacturer (ODM) associated with computing device 102 and/or graphics processor 106_{1-N} may define topologies and/or parameters (e.g., display resolution, display timing) associated with the scanout from graphics processor 106_{1-N} (e.g., shown as graphics ODM 304 in FIG. 3). In one or more embodiments, based on graphics ODM 304, graphics driver component 302 may be configured to control topologies and/or parameters associated with the scanout.

The scanout topologies and/or resolution may be fixed but the corresponding individual displays 104_{1-N} may be of incompatible size(s) such that the image collectively rendered on individual displays 104_{1-N} following scanout may overshoot the dimensions of display unit 104 including individual displays 104_{1-N}.

In order to overcome the aforementioned issue, exemplary embodiments may enable a user (e.g., user 150 shown in FIG. 1) to define a custom mode through graphics driver component 302 that is interpretable through operating system 110. In one or more embodiments, the custom mode may provide a capability to receive information from user 150 regarding the dimensions of the size of display unit 104 including individual displays 104_{1-N}. In one or more embodiments, if a graphics processor 106_{1-N} does not deem the dimensions of an individual display 104_{1-N} of display unit 104 to be appropriate enough to include all of the corresponding pixel data therewithin, the pixel data may be scaled to fit within the dimensions of display unit 104.

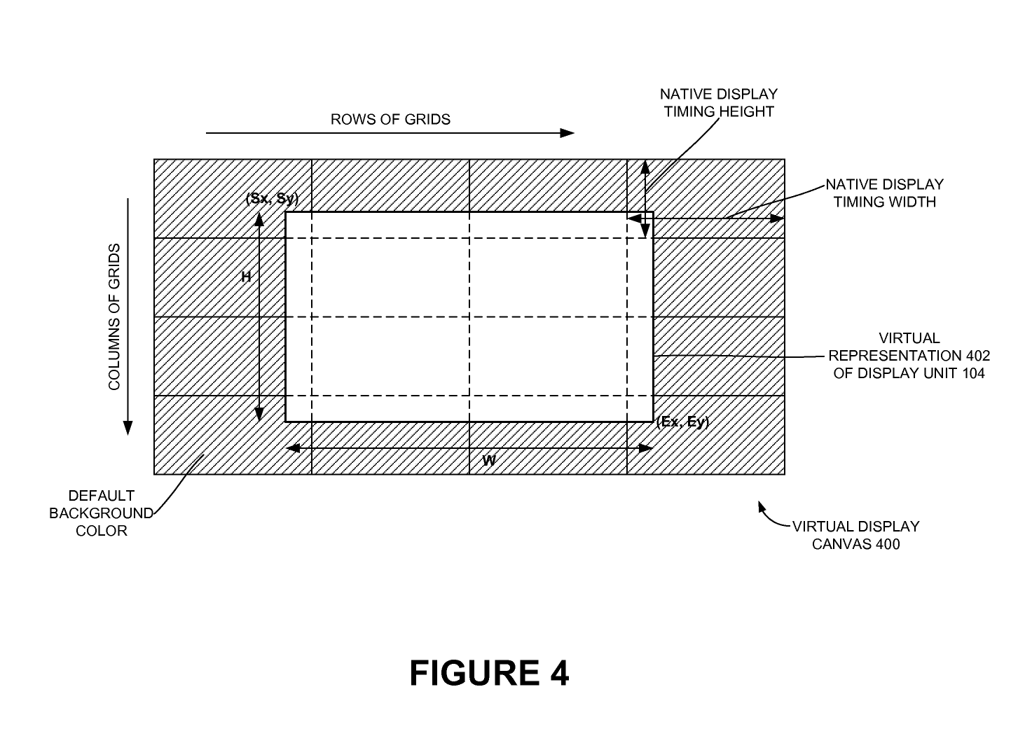

FIG. 4 shows virtual display canvas 400 (analogous to display canvas 200) as including an area corresponding to a virtual representation (e.g., virtual representation 402) of display unit 104 provided by operating system 110 based on interpretation of the custom mode. FIG. 4 shows a 4×4 grid topology as a reference, thereby implying that there are 16 graphics processors 106₁₋₁₆ corresponding to individual displays 104₁₋₁₆. User 150 may input the dimensions of display unit 104 in several forms. For example, user 150 may input the starting coordinates of the virtual representation of display unit 104 as (Sₓ, S_{y}) and the ending coordinates of the virtual representation of display unit 104 as (Eₓ, E_{y}) within virtual display canvas 400. Based on the input starting coordinates and the ending coordinates, graphics processors 106_{1-N} may determine whether the dimensions of display unit 104 are enough to accommodate all pixel data corresponding to virtual display canvas 400.

As shown in FIG. 4, in one or more embodiments, the dimensions of display unit 104 may deem it impossible to accommodate all pixel data corresponding to a frame therewith. Therefore, pixel data corresponding to frames of virtual display canvas 400 may be scaled through graphics processors 106₁₋₁₆ to fit within the virtual area of display unit 104. This may ensure a one-on-one mapping between virtual display canvas 400 and display unit 104.

While an example input from user 150 may include starting and ending coordinates as discussed above, it is obvious that other inputs are within the scope of the exemplary embodiments discussed herein. For example, user 150 may input the starting coordinates alone, along with the height (H) and the width (W) of the virtual representation of display unit 104. The ending coordinates may then be calculated from the starting coordinates and the height and the width of the virtual representation of display unit 104 through a simple linear transformation. The ending coordinates (Eₓ, E_{y}) may be, in one example embodiment, obtained from the starting coordinates (Sₓ, S_{y}) as:

(Eₓ,E_{y})=(Sₓ+W,S₃+H)

It should be understood that the abovementioned examples of inputs from user 150 should not be considered limiting. For example, the ending coordinates, the height (H) and the width (W) of the virtual representation of display unit 104 may be provided by user 150, based on which the starting coordinates may be derived. Variations in the coordinate system utilized to represent virtual display canvas 400 (and virtual representation of display unit 104), variations in the input parameters themselves et al. are also within the scope of the exemplary embodiments.

Virtual display canvas 400 may be divided into grids corresponding to the number of individual displays 104₁-N (N=16 in FIG. 4) of display unit 104. Each grid may correspond to a row and a column of virtual display canvas 400. It is obvious that the virtual representation of display unit 104 may also be divided into the same number of grids (and rows and columns) as virtual display canvas 400. Further, it is obvious that pixel data of each frame corresponding to virtual display canvas 400 may also be scaled to fit within the virtual representation of display unit 104. The row and the column of the virtual representation of display unit 104 within virtual display canvas 400 from which an image is to be generated (or, scanned) may be determined based on a native display timing width and a native display timing height corresponding to virtual display canvas 400. Also, the row and the column of the virtual representation of display unit 104 within virtual display canvas 400 at which the image generation is to end may be determined based on the native display timing width, the native display timing height and the starting coordinates.

Once the abovementioned parameters are determined, the scaled pixel data may be rendered on display unit 104. In one or more embodiments, as the pixel data is scaled, the image rendered on display unit 104 may not overshoot dimensions thereof. In one or more embodiments, when dimensions of the virtual representation of display unit 104 fit within virtual display canvas 400, the portion of virtual display canvas 400 not corresponding to the scaled pixel data may be rendered with a default background color (e.g., black) on display unit 104. It is obvious to note that the aforementioned rendering of a default background color may not be required when dimensions of the virtual representation of display unit 104 exactly fit within virtual display canvas 400.

Thus as discussed above, in one or more embodiments, the custom mode may enable a one-on-one mapping between display unit 104 and virtual display canvas 400. In one or more embodiments, the custom mode may support a list of resolutions. Therefore, in one or more embodiments, if a frame to be rendered has a resolution lower than the resolutions supported by the custom mode, pixel data corresponding to the frame may be scaled up in resolution appropriately to be supported by the custom mode.

While exemplary embodiments have been discussed with regard to a number of graphics processors 106_{1-N}, it is obvious that the concepts discussed herein are also valid for a single graphics processor 106₁ and a single display 104₁. Exemplary embodiments provide for a means to render images that fit on display unit 104 despite the incompatibility in size between a virtual representation of display unit 104 and virtual display canvas 400.

Further, as discussed above, concepts involved in the exemplary embodiments also apply to data from graphics processors 106_{1-N} on different computing devices being rendered on display unit 104. In this case, the computing devices may be communicatively coupled to each other through a communication network such as a LAN and/or a WAN. Here, either graphics processors 106_{1-N} of the different computing devices may be made to function as a single graphics processor or rendering of a collective image on display unit 104 may be performed through a master processor associated with the computing devices. The coordinate system may be defined and adapted through the master processor.

Furthermore, the input of dimensional data from user 150 should not be considered limiting as the aforementioned reception of dimensional data of display unit 104 may be automated (e.g., through distance and position sensors).

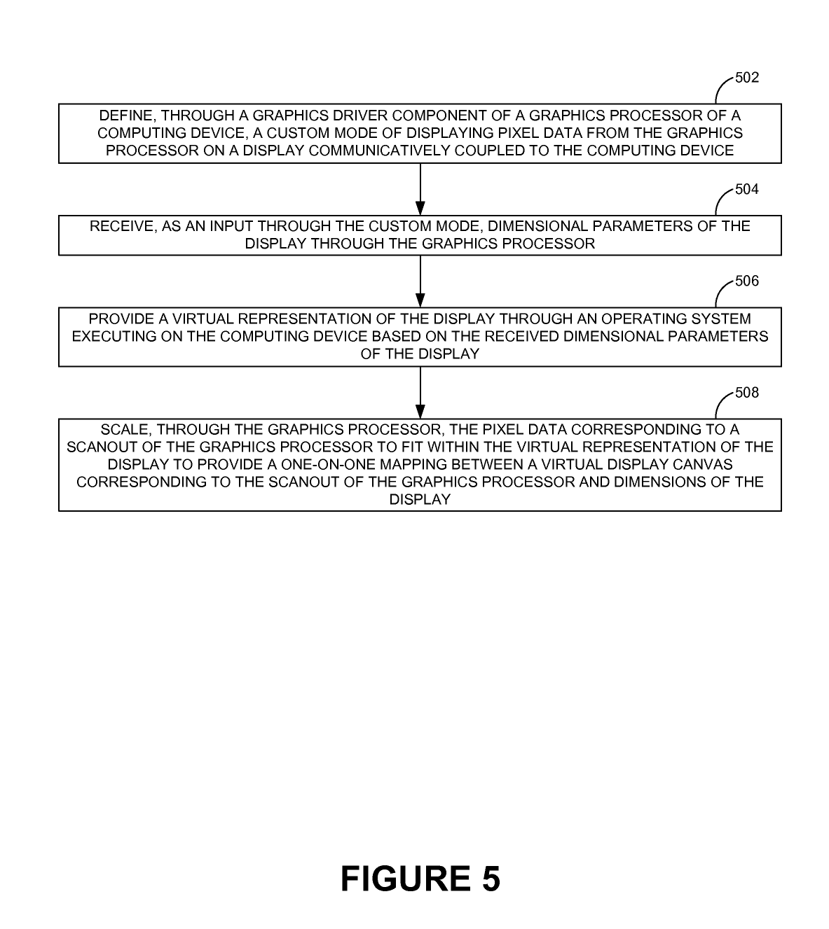

FIG. 5 shows a process flow diagram detailing the operations involved in accommodating display data corresponding to a scanout area of a graphics processor 106₁-N within an incompatible display 104_{1-N}, according to one or more embodiments. In one or more embodiments, operation 502 may involve defining, through a graphics driver component 302 of graphics processor 104_{1-N} of computing device 102, a custom mode of displaying pixel data from graphics processor 106_{1-N} on display 104_{1-N} communicatively coupled to computing device 102. In one or more embodiments, the custom mode may be interpretable through an operating system 110 executing on computing device 102. In one or more embodiments, operation 504 may involve receiving, as an input through the custom mode, dimensional parameters of display 104_{1-N} through graphics processor 106_{1-N}.

In one or more embodiments, operation 506 may involve providing a virtual representation of display 104_{1-N} through operating system based 110 on the received dimensional parameters of display 104_{1-N}. In one or more embodiments, operation 508 may then involve scaling, through graphics processor 106_{1-N}, the pixel data corresponding to a scanout of graphics processor 106_{1-N} to fit within the virtual representation of display 104_{1-N} to provide a one-on-one mapping between a virtual display canvas (e.g., virtual display canvas 400) corresponding to the scanout of graphics processor 106_{1-N} and dimensions of display 104_{1-N}.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a non-transitory machine-readable medium). For example, the various electrical structure and methods may be embodied using transistors, logic gates, and electrical circuits (e.g., Application Specific Integrated Circuitry (ASIC) and/or Digital Signal Processor (DSP) circuitry).

In addition, it will be appreciated that the various operations, processes, and methods disclosed herein may be embodied in a non-transitory machine-readable medium and/or a machine accessible medium compatible with a data processing system (e.g., a computer device), and may be performed in any order (e.g., including using means for achieving the various operations). Various operations discussed above may be tangibly embodied on a non-transitory machine-readable medium readable through computing device 102 to perform functions through operations on input and generation of output. These input and output operations may be performed by a processor (e.g., graphics processors 106_{1-N}). The non-transitory machine-readable medium readable through computing device 102 may be, for example, a memory (e.g., hard disk), a transportable medium such as a Compact Disc (CD), a Digital Video Disc (DVD), a Blu-ray™ disc, a floppy disk, or a diskette. The non-transitory machine-readable medium may include instructions embodied therein that are executable on computing device 102.

A computer program embodying the aspects of the exemplary embodiments may be loaded onto computing device 102. The computer program is not limited to specific embodiments discussed above, and may, for example, be implemented in an operating system, an application program, a foreground or a background process, a driver, a network stack or any combination thereof. For example, software associated with graphics driver component 302 may be available on the non-transitory machine-readable medium readable through computing device 102. The computer program may be executed on a single computer processor or multiple computer processors.

Accordingly, the specification and drawings are to be regarded in an illustrative rather than a restrictive sense.

What is claimed is:

1. A method comprising:
defining, through a graphics driver component of a graphics processor of a computing device, a custom mode of displaying pixel data from the graphics processor on a display communicatively coupled to the computing device, the custom mode being interpretable through an operating system executing on the computing device;
receiving, as an input through the custom mode, dimensional parameters of the display through the graphics processor;
providing a virtual representation of the display through the operating system based on the received dimensional parameters of the display; and
scaling, through the graphics processor, the pixel data corresponding to a scanout of the graphics processor to fit within the virtual representation of the display to provide a one-on-one mapping between a virtual display canvas corresponding to the scanout of the graphics processor and dimensions of the display.

2. The method of claim 1, further comprising one of:
receiving starting coordinates and ending coordinates of the virtual representation of the display as the input through the custom mode;
receiving the starting coordinates, a height and a width of the virtual representation of the display as the input through the custom mode; and
receiving the ending coordinates, the height and the width of the virtual representation of the display as the input through the custom mode.

3. The method of claim 1, further comprising:
rendering, through the graphics processor, a portion of the virtual display canvas not corresponding to the scaled pixel data with a default background color on the display.

4. The method of claim 1, further comprising:
scaling up the pixel data in resolution through the graphics processor when the pixel data to be rendered on the display has a resolution lower than a resolution supported by the custom mode.

5. A display system comprising:
a display unit including a plurality of individual displays; and
a computing device communicatively coupled to the display unit and comprising:
a memory including an operating system executing on the computing device;
a plurality of graphics processors communicatively coupled to the memory, each graphics processor of the plurality of graphics processors corresponding to an individual display of the plurality of individual displays; and
a graphics driver component of the plurality of graphics processors to define a custom mode of displaying pixel data from the plurality of graphics processors on the display unit, the custom mode being interpretable through the operating system executing on the computing device, the customer mode providing a capability to receive dimensional parameters of the display unit as an input through the plurality of graphics processors, the operating system being capable of providing a virtual representation of the display unit based on the received dimensional parameters of the display unit, and the plurality of graphics processors being configured to scale the pixel data corresponding to a scanout of the plurality of graphics processors to fit within the virtual representation of the display unit to provide a one-on-one mapping between a virtual display canvas corresponding to the scanout of the plurality of graphics processors and dimensions of the display unit.

6. The display system of claim 5, wherein the plurality of graphics processors is configured to receive one of:
starting coordinates and ending coordinates of the virtual representation of the display unit as the input through the custom mode,
the starting coordinates, a height and a width of the virtual representation of the display unit as the input through the custom mode, and
the ending coordinates, the height and the width of the virtual representation of the display unit as the input through the custom mode.

7. The display system of claim 5, wherein the plurality of graphics processors is configured to render a portion of the virtual display canvas not corresponding to the scaled pixel data with a default background color on the display unit.

8. The display system of claim 5, wherein the plurality of graphics processors is further configured to scale up the pixel data in resolution when the pixel data to be rendered on the display unit has a resolution lower than a resolution supported by the custom mode.

9. The display system of claim 5, wherein the computing device and the display unit are communicatively coupled to each other through one of: a cable and a communication network.

10. The display system of claim 5,
wherein the plurality of graphics processors is part of a single graphics processor having a corresponding plurality of ports, and
wherein each port of the plurality of ports corresponds to the individual display of the plurality of individual displays to which the each graphics processor of the plurality of graphics processors also corresponds to.

11. The display system of claim 6,
wherein each individual display of the plurality of displays corresponds to a grid on the virtual display canvas and includes a row and a column number associated therewith, and
wherein the plurality of graphics processors is configured to at least one of:
determine a row and a column of the virtual representation of the display unit within the virtual display canvas from which an image corresponding to the scaled pixel data is to be generated based on a native display timing width and a native display timing height corresponding to the virtual display canvas, and
determine a row and a column of the virtual representation of the display unit within the virtual display canvas at which the image generation is to end based on the native display timing width, the native display timing height and the starting coordinates.

12. The display system of claim 9, wherein the communication network is at least one of: a Local Area Network (LAN) and a Wide Area Network (WAN).

13. The display system of claim 5, wherein the plurality of individual displays is a plurality of Liquid Crystal Displays (LCDs).

14. The display system of claim 5,
wherein the display unit further comprises at least one another individual display communicatively coupled to another computing device including at least one another graphics processor corresponding to the at least one another individual display, and
wherein pixel data processed at the another computing device is configured to be rendered on the display unit through the at least one another individual display of the display unit.

15. A non-transitory medium, readable through a computing device and including instructions embodied therein that are executable through the computing device, comprising:
instructions to define, through a graphics driver component of a graphics processor of the computing device, a custom mode of displaying pixel data from the graphics processor on a display communicatively coupled to the computing device, the custom mode being interpretable through an operating system executing on the computing device; and
instructions to receive, as an input through the custom mode, dimensional parameters of the display through the graphics processor;
instructions to provide a virtual representation of the display through the operating system based on the received dimensional parameters of the display; and
instructions to scale, through the graphics processor, the pixel data corresponding to a scanout of the graphics processor to fit within the virtual representation of the display to provide a one-on-one mapping between a virtual display canvas corresponding to the scanout of the graphics processor and dimensions of the display.

16. The non-transitory medium of claim 15, further comprising at least one of:
instructions to receive starting coordinates and ending coordinates of the virtual representation of the display as the input through the custom mode;
instructions to receive the starting coordinates, a height and a width of the virtual representation of the display as the input through the custom mode; and
instructions to receive the ending coordinates, the height and the width of the virtual representation of the display as the input through the custom mode.

17. The non-transitory medium of claim 15, further comprising:
instructions to render, through the graphics processor, a portion of the virtual display canvas not corresponding to the scaled pixel data with a default background color on the display.

18. The non-transitory medium of claim 15, further comprising:
instructions to scale up the pixel data in resolution through the graphics processor when the pixel data to be rendered on the display has a resolution lower than a resolution supported by the custom mode.

19. The non-transitory medium of claim 15, further comprising:
instructions to enable functioning of the graphics processor in conjunction with another graphics processor of another computing device communicatively coupled to another display such that the scaled pixel data of the computing device is rendered along with scaled pixel data of the another computing device on the display and the another display respectively.

20. The non-transitory medium of claim 15, further comprising:
instructions to enable functioning of the graphics processor in conjunction with another graphics processor of the computing device corresponding to another display communicatively coupled to the computing device such that the scaled pixel data corresponding to the graphics processor is rendered along with scaled pixel data corresponding to the another graphics processor on the display and the another display respectively.
